(19) United States
(12) Patent Application Publication
(10) Pub. No.: US 2013/0236592 A1
(43) Pub. Date: Sep. 12, 2013

(54) Food Product

(71) Applicant: Cosme Cruz, Chicago, IL (US)

(72) Inventor: Cosme Cruz, Chicago, IL (US)

(21) Appl. No.: 13/478,677

(22) Filed: May 23, 2012

Related U.S. Application Data
(60) Provisional application No. 61/490,408, filed on May 26, 2011.

(51) Int. Cl. A23L 1/29; A21D 10/00

(52) U.S. Cl. CPC A23L 1/296; A21D 10/002
USPC 426/2; 426/549; 426/551

(57) ABSTRACT

A food product containing high affinity phosphate binders (calcium and magnesium) for the purpose of chelating phosphate forms ingested foods and preventing its absorption. The chelation of phosphate in the intestine is an important part of the management of patients with moderate to severe renal failure including those in the predialysis and the dialysis dependent stages. The medicinal food product is a palatable source of calcium and magnesium which if taken without meals can be used as means to supplement those ions/salts. This concept of “food as medicine” represents a major reinforcement in the prevention and management of the derangements of divalent ion metabolism present at all levels of renal insufficiency. Limiting the gastrointestinal absorption of phosphate and consequently preventing the elevation of plasma phosphate, retards the onset of renal osteodystrophy (a Metabolic Bone Disease) and soft tissue calcification.

### FIELD OF THE INVENTION

The invention relates generally to consumable foods which provide medicinal value. More specifically, the invention relates to foods that provide medicinal value to kidney dialysis patients in the form of chelating unwanted substances and/or providing ionic compounds necessary for body function of ionic compounds necessary for body function.

### BACKGROUND OF THE INVENTION

The kidneys have an important rote in maintaining health. When healthy, the kidneys maintain the body's internal equilibrium of water and dissolved minerals (sodium, potassium, chloride, calcium, phosphorus, magnesium, sulfate). Those acidic end products of metabolism that the body cannot get rid of via respiration are excreted through the kidneys. The kidneys also function as part of the endocrine system producing erythropoietin and calcitriol. Erythropoietin is involved in the production of red blood cells and calcitriol plays a role in bone formation.

Renal failure is described as a decrease in the glomerular filtration rate. Biochemically, renal failure is typically detected by an elevated serum creatinine level. Problems frequently encountered in kidney malfunction include abnormal fluid levels in the body, deranged acid levels, abnormal levels of potassium, calcium, phosphate, and (in the longer term) anemia as well as delayed healing of broken bones. Depending on the cause, hematuria (blood loss in the urine) and proteinuria (protein loss in the urine) may occur.

The cause of renal failure can be divided into two categories: acute kidney injury or chronic kidney disease. The type of renal failure is determined by the trend in the serum creatinine. Other factors which may help differentiate acute kidney injury from chronic kidney disease include anemia and the kidney size on ultrasound. Chronic kidney disease generally leads to anemia and small kidney size.

Symptoms can vary from person to person. Someone in early-stage kidney disease may not feel sick or notice symptoms as they occur. When kidneys fail to filter properly, waste accumulates in the blood and the body, a condition called azotaemia. Very low levels of azotaemia may produce few, if any, symptoms. As the disease progresses, symptoms become noticeable (if the failure is of sufficient degree to cause symptoms). Renal failure, accompanied by noticeable symptoms, is termed uraemia.

Dialysis is an imperfect treatment to replace kidney function; it replaces some functions through diffusion (waste removal) and ultrafiltration (fluid removal), but it does not correct the endocrine functions of the kidney.

The two main types of dialysis, hemodialysis and peritoneal dialysis, remove wastes and excess water from the blood in different ways. Hemodialysis (HD) removes wastes and water by circulating blood outside the body through an external filter, called a dialyzer, that contains a semipermeable membrane. The blood flows in one direction and the dialysate flows in the opposite direction. The counter-current flow of the blood and dialysate maximizes the concentration gradient of solutes between the blood and dialysate, which helps to remove more urea and creatinine from the blood. The concentrations of solutes (for example potassium, phosphorus, and urea) are undesirably high in the blood, but low or absent in the dialysis solution. Constant replacement of the dialysate ensures that the concentration of undesired solutes is kept low on this side of the membrane. The dialysis solution has levels of minerals such as potassium and calcium that are similar to their natural concentration in healthy blood.

In peritoneal dialysis (PD), wastes and water are removed from the blood inside the body using the peritoneal membrane of the peritoneum as a natural semipermeable membrane. Wastes and excess water move from the blood, across the peritoneal membrane, and into a special dialysis solution, called dialysate, in the abdominal cavity which solution has a composition similar to the fluid portion of blood.

In peritoneal dialysis, a sterile solution containing glucose is run through a tube into the peritoneal cavity, the abdominal body cavity around the intestine, where the peritoneal membrane acts as a semipermeable membrane. The peritoneal membrane or peritoneum is a layer of tissue containing blood vessels that lines and surrounds the peritoneal, or abdominal, cavity and the internal abdominal organs (stomach, spleen, liver, and intestines). The dialysate is left there for a period of time to absorb waste products, then it is drained out through the tube and discarded. This cycle or “exchange” is normally repeated 4-5 times during the day, (sometimes more often overnight with an automated system). An exchange is each time the dialysate fills and empties from the abdomen. Dwell time means the time the dialysate stays in the patient's abdominal cavity—wastes, chemicals and extra fluid move from the patient's blood to the dialysate across the peritoneum.

Traditional dialysis methods have been used to arrest many of the symptoms of renal failure. However, washing the blood with dialysis solution commonly depletes the body of various electrolytes (sugars and salts), necessary to maintain bodily function. As a result, dialysis solutions commonly contain sugars such as dextrose, carbonates and lactates to assist in buffering and maintaining blood functionality for such processes as chelation. These solutions also contain salts of, for example, sodium, calcium and magnesium to maintain the functionality of the neurological system (brain and nervous system).

Examples of these dialysate solutions may be found for example in U.S. Pat. No. 6,673,376 which teaches dialysis solution of acid and carbonate which allows the use of solid acid sources to limit the emission of CO₂. Wu et al., U.S. Pat. No. 6,812,222 teaches a peritoneal dialysis solution of amino sugars designed to promote reversal of water by diffusion. Naggi et al., U.S. Pat. No. 7,208,479 teaches a peritoneal dialysis solution of glucose compounds that are heat stable under sterilization conditions. Martis et al., U.S. Pat. No. 7,618,392 teaches methods and compositions for detection of microbial contaminants in peritoneal dialysis compositions. Both of U.S. Pat. Nos. 6,803,363 and 7,550,446 also teach dialysis solutions and plasma expanders.

Apart from pH balance issues, dehydration and irregular neurological function, another common problem that may occur with kidney dialysis patients is the buildup of salts on the bones and in the joints. Common hypercalcemia may ensue in which the patient may develop deposits of calcium and which may lead to any number of problems including severe arthritis and bone deformation.

Other problems are also created by various ionic species and their presence in the diasylate solutions. For example, dialysis patients commonly have constipation problems. Cramping, often in the lower extremities such as the legs and abdomen, is also common.

While these basic dialysis solutions prove useful, the presence of certain salts such as calcium and magnesium can build up in the soft tissue in body and lead to the formation of bone deformities and even more serious medical events. While the exclusion of these salts from the diasylate may exclude these deformities, certain salts are necessary for normal neurologic function. Further, prior salt supplements (calcium and magnesium), have proven unacceptable either as inappropriate vessels to supplement necessary salts for absorption into the body or as being unpalatable or unabsorbable by human consumption.

Heretofore, such problems have not been successfully addressed by the prior art. As such, there is a need for food articles which supplement necessary body salts for patients undergoing active kidney dialysis.

### SUMMARY OF THE INVENTION

In accordance with the invention, there is provided dough for baked food product, the dough for supplementing ionic calcium and magnesium concentration in the human blood stream, the composition comprising flour in an amount necessary to form a baked food product, plasticizer in an amount necessary to provide a pliable palatable baked food product, from about 50 to 300 Magnesium salt; from about 500 to 2000 Calcium salt; and a balance of water.

The timing for a new treatment modality for patients suffering from End-Stage Renal Disease (ESRD) could not be better. In-Center Hemodialysis (HD), is a costly treatment modality, fraught with numerous impediments due to a highly individualized approach to its prescription and delivery. It is based on an ultra-efficient and “fast” treatment schedule of, on average, 12 hours per week (240 min. 3× per week).

Thought by many as failing to rehabilitate patients, and limiting of their lifestyle, the rapid fluid and toxin removal associated with HD makes for wide fluctuations in body fluid and chemical composition. Thus, severe dietary restrictions are needed. Patient non-compliance is rampant and results in the frequent need for hospitalizations, due to serious morbidity and mortality events. The relatively recent awareness of yet one more serious and often fatal complication of HD makes any advances even more pertinent: The development of soft tissue (primarily cardiac and vascular) calcification. This issue has increasingly been identified as the “Achilles heel” of the ESRD replacement therapy as we know it.

As an alternative to HD, peritoneal dialysis offers some advantages such as it being continuous, allowing the patient to adapt the dialysis schedules to their needs, having virtually no dietary restrictions, allowing the patient freedom to work and travel, restoring reproductive function, etc. Peritoneal dialysis, however, suffers from lack of technological refinements, with virtually no major advancement in the last twenty years.

Inefficient and easily contaminable equipment and delivery systems, coupled with irritating, unphysiologic dialysis solutions that shorten the effective life of the peritoneal membrane (the actual dialysis surface) have contributed to a rather limited utilization of this technique. As in HD, but not to the same degree, soft tissue calcification and slowing of the normal bone remodeling process are also recognized as significant problems in acute need of solution.

Calcium-based phosphate chelating agent (with additional magnesium sulfate and, possibly, minute amounts of zinc) may improve ion metabolism. These preparations are being proposed to be delivered in a palatable vehicle (pastry; cookie; bread stick; or “chip”) to be eaten during meals. Thus, the chelating of phosphate would take place in the intestine, and the calcium/phosphate products would be eliminated in the excrement. This scenario is more appropriate, as opposed to the present situation where the phosphate chelating is done in the blood stream or the peritoneal space by the calcium present in the dialysis fluid. This “intra vascular” chelating of the abnormally high phosphate (a universal occurrence in ESRD) is the phenomenon responsible for soft tissue calcification seen in HD and, to a lesser extent, in PD. Currently research has yielded no effective means to eliminate excessive calcium and magnesium from HD or PD fluid formations.

### DETAILED DESCRIPTION OF THE PREFERRED EMBODIMENTS

In accordance with the invention there is provided a dough for use in preparation of a baked food product for supplementing ionic calcium and magnesium concentration in the human blood stream. The composition comprises flour in an amount necessary to form a dough product as well as a plasticizer, and magnesium and calcium.

The composition of the invention generally comprises a dough. The dough acts to provide physical stability to the foodstuff while also providing the necessary consistency and thermal stability for a foodstuff which is baked. Additionally, the dough provides a medium which is preferably compatible with any foodstuff, topping, or filling with which it is combined and physically adequate to support and deliver this foodstuff, topping, or filling.

The dough may comprise any number of constituents consistent with this function. Generally, the dough of the invention comprises a processed or unprocessed flour which may be either a white flour or a whole grain constituent. Grains useful for defining the dough of the invention include grain constituents such as flours, germ, and bran from wheat, oats, rye, sorghum, barley, rice, millet, and corn among others. Generally, the dough used in the invention will have flour present in a concentration ranging from about 55 wt-% to 70 wt-%, preferably about 60 wt-% to 65 wt-%, and most preferably about 61 wt-% to 62 wt-%.

Additionally, the dough of the invention may comprise plasticizer such as a fat or fat substitute present in the form of any number of natural or synthetic oils including various vegetable oils such as corn oil, soy bean oil and the like. Also useful for defining the fat content of the dough of the invention are oils derived from animals such as shortening or lard as well as synthetic plasticizers such as propylene glycol or glycerol. The plasticizer content of the dough of the invention can generally range from about 10 wt-% to 35 wt-%, preferably about 15 wt-% to 30 wt-%, and most preferably about 20 wt-% to 25 wt-% to optimize bread layer texture and minimize toughness and hardness after pre-baking.

The dough of the invention may also comprise water. Preferably, the dough moisture will range from about 0 wt-% to 50 wt-%, preferably from about 2 wt-% to 30 wt-%, and most preferably about 5 wt-% to 10 wt-% to limit the decrease in crispness often occurring with excessive amounts of water.

Another means of measuring the concentration of water is in terms of the ratio of water to flour in the dough. To this end, we have found that a water to flour ratio of about 0 to 0.5, preferably about 0.1 to 0.3, and most preferably 0.1 to 0.2 to be most conducive to optimal crispness.

The food product of the invention may be leavened or unleavened. To this end, along with other constituents, the dough of the invention may also comprise a leavening agent. We have found that the stressed crispness of the composition of the invention generally increases after microwaving as the dough specific volume is increased due to the addition of leavening agents. The leavening agent may be present in the dough composition at concentrations ranging from about 0 wt-% to 3 wt-%, preferably about 0.5 wt-% to 2 wt-%, and most preferably about 1 wt-% to 2 wt-%.

Leavening agents useful in the invention include air, steam, yeast and baking powders such as those containing sodium bicarbonate and the combination of one or more baking acids with sodium bicarbonate. Baking acids useful for chemical leavening in dough mixtures include monocalcium phosphate monohydrate, sodium aluminum sulfate, sodium acid pyrophosphate, sodium aluminum phosphate, dicalcium phosphate, glucono-delta lactone, and potassium hydrogen tartrate, and mixtures thereof. One or more baking acids may be combined with the sodium bicarbonate to form the chemical leavening agent. Preferably, the dough of the invention comprises from about 0.3 wt-% to 0.7 wt-% sodium bicarbonate.

Along with the leavening agent, the dough of the invention may also comprise any number of other constituents as known to those skilled in the art including sugar, salt, emulsifiers, dyes, flavorants, and other constituents.

The invention may also comprise an emulsifier. Generally, the emulsifier functions with the shortening and protein supplement to reduce doughiness in the interior of the baked product and provide a crisp outer crust. The emulsifier, along with protein and shortening, provides an appealing tender texture to the interior portion of the baked product. Emulsifiers may also be incorporated into the dough to influence texture of homogeneity of the dough mixture, to increase dough stability, to improve eating quality, and to prolong palatability. Emulsifying agents which may be used include mono- and diglycerides of fatty acids, propylene glycol mono- and di-esters of fatty acids, glycerol-lactose esters of fatty acids, ethoxylated or succinylated mono- and diglycerides, lecithin, diacetyl tartaric acid esters or mono- and diglycerides, sucrose esters of glycerol, or equivalents thereof and mixtures thereof. Emulsifying agents may be used singly or in combination. Preferred emulsifiers include mixtures of diacetyl tartaric acid esters, and succinylated mono- and diglycerides. The mix and dough of the invention may also comprise any number of other constituents as known to those of skill in the art including sugar, salt, dyes, flavorants, and other constituents.

The composition of the invention may additionally comprise sugar. The sugar acts as a sweetener and bulking agent providing improved taste and higher moisture mouthfeel in the baking composition. The sugar in the baking composition dissolves quickly upon consumption which provides a moist and tender mouthfeel. The addition of too much sugar results in an insufficient amount of flour being present in the baking composition. Thus, a baked good prepared from a composition with too much sugar will collapse.

In contrast, too little sugar in the baking composition affords a baked good with poor taste and mouthfeel. The baked good has poor organoleptic properties because there is not enough sweetener in the baking composition. The baked product has a dry mouthfeel because there is an insufficient amount of sugar in the composition to have the tender or moist mouthfeel.

Among other optional ingredients which may be added to the dough mixture are dough relaxants, mold inhibitors (antimycotics), various enriching ingredients, and shortening. Dough relaxers such as 1-cysteine, may be added to facilitate sheeting of the dough particularly with industrial size equipment. Mold inhibitors aid in extending the shelf life of the foodstuff product and may include sodium bean salts of propionic and sorbic acids, sodium diacetate, vinegar, monocalcium phosphate, lactic acid, and mixtures thereof.

Enrichment nutrients which may be added to the dough may include thiamine, riboflavin, niacin, iron, calcium, and mixtures thereof. Shortening such as animal and vegetable fats and oils may be added as a tenderizer, preservative, and to build air cell structure to provide a dough with a desirable mouthful. Other ingredients which may be optionally added to the dough mixture include seasonings, extenders, preservatives, and food colorings as desired.

### Divalent Metabolic Salts

Ionic phosphate (PO₄) occurs in the human body through any number of sources. Generally, phosphates are an integral portion of enzymatic and metabolic function. However, excessive phosphate concentration leads to any number of problems including the extraction by chelation of divalent ions necessary for neuro muscular activity and for maintaining the integrity of the human skeletal system.

At the same time, a paramount concern with dialysis patients is maintaining an active concentration of calcium and magnesium in the blood. Commonly, as dialysis solution is infused into the peritoneum to wash the blood, vital ions are removed from the blood with waste products as they exit the body. Balancing divalent ions, (Mg⁺² and Ca⁺²), with phosphate in concentration is an essential aspect of a person's daily routine. Calcium and magnesium are lost from the body through urination and sweat glands.

Corresponding the expected loss of calcium and magnesium in dialysis patients is the loss of these divalent ions through dialysis. Simply replacing these ionic salts through a balanced diasylate solution often proves problematic. In certain situations the calcium and magnesium is not broken down and absorbed by the body. If for example in other situations, calcium ions chelate with available phosphate ions in the blood stream, there may be no metabolic pathway to expel these salts from the body. Calcium can build upon soft tissue. This phenomenon leads to calcification of soft tissues of the body such as the tissues of the heart, blood vessels and brain. There is also evidence that the presence of excessive calcium salts (eg., calcium phosphate) shuts down hormonal influence over orderly bone remodeling creation. This can lead to calcium deposits on the skeletal system such as bone spurs, calcification of joints, and abhorrent bone growth among other problems.

The present invention alleviates these problems by providing a food product which significantly reduces if not eliminates the need for calcium and magnesium ions to be present in solutions used to dialyze patients with kidney failure.

In the preparation of the baked food product of the invention any calcium and magnesium salts may be used which are organoleptically acceptable. Useful salts include carbonate, silicate, nitrate, sulfate, iodate, perchlorate, and tungestate salts of calcium and magnesium. Other useful salts include hydride carbide, silicade, oxide, fluoride, chloride and hydroxide salts of magnesium and calcium.

Baking the composition of the invention is within the skill in the art. One set of exemplary concentrations for constituents which may be used to formulate doughs in accordance with the invention are found in the Table below.

TABLE
(100 gm batch)

| | | |
|---|---|---|
| Useful | Preferred | More Preferred |

| | | | | | | |
|---|---|---|---|---|---|---|
| Flour | 10-50 | gm | 10-25 | gm | 15-25 | gm |
| Emulsifier | 2-20 | gm | 2-10 | gm | 5-10 | gm |
| Magnesium | 100 | mg | 75-125 | mg | 50-150 | mg |
| Calcium | 1000 | mg | 750-1000 | mg | 500-1500 | mg |

| | | | |
|---|---|---|---|
| Water | q.s | q.s | q.s |

### WORKING EXAMPLE

The following Examples provide a nonlimiting illustration of certain embodiments of the invention.

### Example 1

Cookies with 1000 mg calcium and 100 mg magnesium (makes ten cookies)
195 g organic flour
65 g sugar
⅛ tsp. baking soda
1 organic egg
½ tsp. vanilla
85 g butter

Mix dry ingredients, flour, sugar, baking soda together. Add 1000 mg calcium and 100 mg magnesium to dry ingredients. Sift three times through fine sieve to assure everything is well incorporated. Mix wet ingredients into the dry ones and combine well. Shape into a log and divide into 10 equal balls (35 g). Flatten each ball with the bottom of a glass that has been dipped into sugar. Bake in 375 degree oven for 9 to 11 mins.

### Example 2

Tortilla Chips with 1000 mg calcium and 100 mg. magnesium
500 g organic corn flour
¼ tsp. salt
3 Tbsp. corn oil
65 g warm water
10000 mg calcium
100 mg magnesium

Combine flour and salt. Add calcium and magnesium and sift into flour and salt (sift three times through fine sieve to assure its evenly mixed). Slowly stir in corn oil until its incorporated throughout the dry mixture. Add warm water until all the flour is moist and sticks together. Add a little more if necessary. Knead for 1 to 2 mins. then place on floured surface and divide into ten equal pieces (55 g each). Shape pieces into 2 to 3 inch flat circles. Cover with plastic and let rest for 30 mins. Roll into larger 6 inch circles and place on baking sheet with an inch between then cut each into smaller sections but keep these in place. Bake in 350 degree oven for 9 mins. or until lightly brown.

### Example 3

Cookies Containing Calcium Carbonate (Ca+CO₃) □to be used as Phosphate Binder.
6 Nov. 2010
1017 Lakeshore Road
Gross Pte Farms, Mich. 48236
Experiment Calcium Carbonate Cookies

Shirleann and Cosme Cruz
Ingredients: Organic whole wheat flour, butter, vanilla extract, Sugar, Calcium Carbonate

Each Cookie weighs approximately 10 including 1 g Calcium Carbonate (Ca+CO₃) baked in conventional oven for 12 to 15 minutes until light brown.

Cosmetic Results:
Appearance Good
Smell Good
Texture Good—no noticeable grittiness
Taste Excellent

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice In the art to which this invention pertains and which fall within the limits of the following claims.

The claimed invention is:

1. A dough for baked food product, said dough for supplementing ionic calcium and magnesium concentration in the human blood stream, said composition comprising:
flour in an amount necessary to form a baked food product;
plasticizer in an amount necessary to provide a pliable palatable baked food product;
from about 50 to 300 Magnesium salt;
from about 500 to 2000 Calcium salt; and
a balance of water.

2. The product of claim 1, wherein said flour is present in a concentration ranging from 40 to 80 wt-%.

3. The product of claim 1, wherein said plasticizer is present in a concentration ranging from about 20 to 50 wt-%.

4. The product of claim 1, wherein said calcium salt is an alkaline or alkaline earth metal salt of calcium.

5. The product of claim 1, wherein said magnesium salt is an alkaline or alkaline earth metal salt of magnesium.

6. The product of claim 1, wherein said plasticizer comprises a compound selected from the group consisting of butter, a natural or synthetic oil, a natural or synthetic fatty acid, and mixtures thereof.

7. The product of claim 1 additionally comprising a leaveing agent an amount ranging from about 5 to 10 grams.

8. A method of chelating phosphate compounds in the human body using the composition of claim 1, said method comprising the steps of:
a.) baking said dough to provide a baked product;
b.) ingesting the baked product; and
c.) chelating available phosphate with said calcium and magnesium in said baked product.
